(19) United States
(12) Patent Application Publication
(10) Pub. No.: US 2009/0118409 A1
(43) Pub. Date: May 7, 2009

(54) Embedding compositions specifically based on metallocene-catalyzed polyolefins, in particular for the encapsulation of electronic instruments and components

(75) Inventors: Rainer Fell, Gersthofen (DE); Hermann Diem, Wehringen (DE); Josef Mayr, Holzheim (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant International Ltd.

(21) Appl. No.: 12/291,241

(22) Filed: Nov. 7, 2008

(30) Foreign Application Priority Data
Nov. 7, 2007 (DE) 10 2007 052 965.3

(51) Int. Cl. C08K 3/26; C08L 23/12; C08L 23/16; C08K 3/00; C08K 3/22; C08K 3/36; C08L 23/06; C08K 3/34

(52) U.S. Cl. 524/427; 524/570; 524/584; 524/586; 524/451; 524/424; 524/449

(57) ABSTRACT

Embedding composition comprising
a) one or more waxes based on metallocene-catalyzed polyolefins which have
   a ring/ball softening point in the range from 50 to 165° C.,
   a melt viscosity, measured at a temperature of 170° C., in the range from 20 to 40 000 mPa·s and
   a glass transition temperature T_{g} of not more than −10° C. and
b) one or more inorganic filler(s).

The embedding compositions are suitable for producing construction materials, in particular for the production of connecting elements for the encapsulation of electronic circuits, electric appliances, motors, pumps, e.g. fixing the stator of immersion pump assemblies, in particular as embedding composition for the stator of an electric motor.

The present invention is described in the German priority application No. 102007052965.3, filed Nov. 7, 2007, which is hereby incorporated by reference as is fully disclosed herein.

Embedding compositions comprising waxes specifically based on metallocene-catalyzed polyolefins, in particular for the encapsulation of electronic instruments and components

The present invention relates to the use of waxes and metallocene-catalyzed polyolefins as encapsulations of electronic circuits, electric appliances, motors, pumps and also individual components and groups of components. Here, waxes and metallocene-catalyzed polyolefins are used as material or as constituent of formulations, in particular in combination with a large amount of filler (e.g. sand).

Polymers, plastics, fillers and mixtures thereof are used for the encapsulation of groups of electrical components. Encapsulation (sand fixing) has hitherto been produced only with the aid of toxic and environmentally polluting materials (e.g. monomers of synthetic resins) or only with the aid of harmful solvents such as petroleum, heavy naphtha, light naphtha and benzene as solvents by the complicated carbonic acid solidification process.

For example, stators of immersion pump assemblies having axial wet-running motors are hermetically encapsulated. This is generally effected by means of a mixture of sand (silica sand), resins (epoxy resin) and additives.

Such an immersion pump assembly is known, for example, from DE-C-36 09 311. The in-principle structure of such assemblies as are predominantly used for conveying pure or slightly contaminated water is also disclosed in this document.

If the embedding material around the component (stator) is omitted, problems can occur. There is a risk of the outside of the end windings coming into direct contact with the housing because of the absence of embedding material and this leading to an electrical short circuit.

A further problem is that there is usually a capacitor located within the stator space, which capacitor is, in the case of known constructions, embedded in the embedding composition and is held within the housing by this. If the embedding composition is absent, it is necessary to provide an additional holder for the capacitor, as a result of which the manufacture of the assembly becomes more complicated.

In addition, depending on the load on the motor, thermal problems can occur within the stator winding when the embedding composition is absent, since the heat evolved there as a result of electric losses can no longer be removed to a sufficient extent.

In addition, the embedding composition has a positive influence on the resonance behavior (resonant vibration behavior) in the case of fast-running groups of components because of its high mass and serves for mechanical stabilization or noise damping and to quieter running.

In general, mixtures of fillers (e.g. sand) and heat-curable synthetic resins, essentially epoxy resin, hardeners and additives are used as embedding composition. Epoxy resins for this application are known. Particularly in the case of embedding of the stators of electric motors, they have to meet particular requirements. Firstly, the embedding composition has to ensure impermeable enclosure of the stator embedded therein in the motor housing and, secondly, has to remove at least part of the heat produced in the stator (heat resulting from electric losses). Finally, the elasticity and strength of the embedding composition have to meet more demanding requirements in all operating states in order to be able to take up vibrations and cyclic mechanical loads occurring during operation.

Disadvantages of an epoxy embedding composition are:
time-consuming manufacturing process due to long curing times, long gelling times, high manufacturing and materials costs
synthetic resins (epoxy resins) usually have a high viscosity and thus display poor penetration into the filler (e.g. sand). The wetting of fillers (sand grains) is usually effected under high pressure
elasticity and mechanical strength of the embedding composition deteriorate after a prolonged period of operation. Epoxy resins harden and become brittle. Cracks are formed both in the sand body and also between sand grains and the wall of the housing. This can result in a shortening of the life
such embedding compositions are elastic only in the high temperature range, but otherwise tend to be brittle so that they show an increased tendency to form cracks
synthetic resins harden and lead to brittle fracture. Sand fixing is no longer ensured. The removal of the heat due to electric losses is no longer given
monomers of epoxy resins are classified as sensitizing and result in odor pollution during processing. Handling of epoxy resins necessitates corresponding precautions in terms of occupational hygiene and safety facilities.

Although the abovementioned brittleness of the embedding composition at low temperatures can be prevented by addition of fibrous materials, the viscosity of the (still liquid) synthetic resin is increased to such an extent that the flowability is considerably reduced. Fibrous additives are generally comparatively expensive. The addition of rubber-like substances to elasticize embedding compositions by formation of elastic phases is likewise known. This, too, has a strong influence on the flowability of the synthetic resin.

The use of polyamines (polyamides) in cold-curing systems is also known. Such additives have hitherto not been used in heat-curing systems since there is a fear that precipitation which has an unfavorable influence on the viscosity will occur and such additives are not sufficiently thermally stable.

It is therefore an object of the present invention to develop an embedding composition for electronic instruments or components, e.g. immersion pump assemblies, which firstly avoids the problems mentioned for the use of an epoxy or polyamide embedding composition and secondly enables materials and manufacturing cost advantages to be achieved, so that efficient production of such assemblies is made possible.

Proceeding from this prior art, it is an object of the invention to provide an embedding composition which does not have the abovementioned disadvantages and to create an inexpensive embedding composition which is suitable for mass production and has a comparatively high elasticity and strength within a wide temperature range so as to prevent the risk of crack formation which is otherwise frequently observed in the case of fast-curing systems. However, this is astonishingly not the case for the embedding composition of the invention.

EP-A-1 290 100 describes polyolefins, in particular copolymers of propylene and hexane, which have storage modulus values G′ of >0.01 Pa and G″/G′ ratios of >18 at G′=10 Pa. These values indicate a high deformation potential of these copolymers.

US 2006-0100335 describes compositions comprising ethylene-C3-C20 copolymers or C3-C30 homopolymers or copolymers and at least 40% by weight of a filler and also their improved processability to produce finished articles, for example films, floor coverings or wall coverings. No information is given on the adhesion properties of these compositions or their use as embedding composition.

None of the above-cited documents suggests the possible use of polyolefins as fixing material or as embedding composition for the encapsulation of electronic circuits, electric appliances, motors, pumps and also individual components and groups of components, for example in concrete, wood, metal, plastic or stone.

It has surprisingly been found that fillers such as sand in combination with waxes, specifically waxes based on metallocene-catalyzed polyolefins, can be used as embedding compositions having increased elasticity and strength.

The present invention accordingly provides embedding compositions comprising:
a) one or more waxes specifically based on metallocene-catalyzed polyolefins and
b) one or more filler(s), in particular inorganic fillers, where the waxes a) have
   a ring/ball softening point in the range from 50 to 165° C.,
   a melt viscosity, measured at a temperature of 170° C., in the range from 20 to 40 000 mPa·s and
   a glass transition temperature T_{g} of not more than −10° C.

The embedding composition of the invention has a comparatively high strength and elasticity over a wide temperature range, which is of particularly high importance in the case of motors subjected to high cyclic load. The embedding composition concerned is therefore particularly useful for the abovementioned process (embedding of the stator of an electric motor) in mass production since the liquid and readily flowable wax or the metallocene-catalyzed polyolefins have very good wetting properties and can be processed without great difficulty at a comparatively low pressure.

The processing pressure for synthetic resins usually has to be increased above a particular level because of high viscosity and there is a risk of the stator winding being damaged: this is not the case when the embedding compositions of the invention are used.

The invention further provides the production and use of the abovementioned embedding composition for the encapsulation of electronic circuits, electric appliances, motors, pumps and also individual components and groups of components.

The polyolefin-based waxes a) are preferably waxes which have been prepared, in particular, by polymerization of ethylene and propylene in the presence of metallocenes as catalyst and preferably have a melt index MFI of more than 30 g/10 min, measured in accordance with ISO 1133 at a temperature of 190° C. and a load of 2.16 kg.

The ratio of loss modulus G″ to storage modulus G′ is preferably <18 at G′=10 Pa. The storage modulus G′ is in the range from 10 000 MPa to 0.0015 MPa, preferably from 1000 MPa to 0.1 MPa, particularly preferably from 100 MPa to 0.2 MPa.

Possible inorganic fillers are many inorganic salts and minerals, with preference being given to sands, chalks, natural milled or precipitated calcium carbonates, calcium-magnesium carbonates, calcium oxide, silicates, barite, graphite and carbon black. Platelet-like fillers such as vermiculite, mica, talc or similar sheet silicates are also suitable as fillers. It may be advantageous for at least part of the fillers to have been surface-treated. Preferred embodiments of the compositions used according to the invention contain a naturally deposited fine beach sand as filler.

The weight ratio of the abovementioned waxes and metallocene-catalyzed polyolefins to inorganic filler in the compositions used according to the invention is in the range from 1:99 to 99:1, preferably from 10:90 to 90:10. In particular, the composition comprises from 61 to 89% by weight of polyolefin and from 11 to 39% by weight of filler, extraordinarily preferably from 65 to 85% by weight of polyolefin to from 15 to 35% by weight of filler.

The embedding compositions used according to the invention preferably contain waxes specifically based on metallocene-catalyzed polyolefins having melt viscosities measured at a temperature of 170° C. of from 50 to 30 000 mPa·s, particularly preferably from 100 to 20 000 mPa·s.

In a preferred embodiment, polyolefins having a number average molar mass Mₙ in the range from 500 to 20 000 g/mol, preferably in the range from 800 to 10 000 g/mol, particularly preferably in the range from 1000 to 5000 g/mol, and a weight average molar mass M_{w} in the range from 1000 to 40 000 g/mol, preferably in the range from 1600 to 30 000 g/mol, particularly preferably in the range from 2000 to 20 000 g/mol and extraordinarily preferably in the range from 2500 to 10 000 g/mol, are used. The molar mass is determined by gel permeation chromatography.

Preference is also given to compositions which comprise waxes and metallocene-catalyzed polyolefins of the abovementioned type whose ratio of loss modulus G″ to storage modulus G′ at G′=10 Pa is in the range from 17 to 0.1, preferably in the range from 10 to 0.2, particularly preferably in the range from 5 to 0.3. G′ and G″ are determined by DMA (dynamic mechanical analysis) using a TA Instruments Q800.

The compositions of the invention contain, in particular, waxes and metallocene-catalyzed polyolefins selected from among homopolymers of propylene and copolymers of propylene and ethylene, with the copolymers preferably comprising from 70 to 99.9% by weight, particularly preferably from 80 to 99% by weight, of one type of olefin.

In a further preferred embodiment, the compositions contain copolymers of propylene and ethylene, with the content of structural units derived from propylene being from 61 % by weight to 99.9% by weight, preferably from 70 to 99% by weight, particularly preferably from 80 to 95% by weight.

In a preferred embodiment, the compositions of the invention contain, in addition to the components a) and b), the component c), where c) is one or more copolymer waxes modified so as to make them polar and prepared by reaction of the polyolefin a) with an α,β-unsaturated carboxylic acid or derivative thereof in the presence of free-radical initiators.

The copolymer waxes which have been modified so as to make them polar mentioned under c) can be prepared by the method described in EP-A-0 941 257. Preference is given to copolymer waxes which have been modified so as to make them polar and are derived from polyolefins, preferably from polypropylene, modified by means of maleic anhydride and/or maleic acid.

The compositions of the invention comprising the components a) and b) or a), b) and c) can be used as construction materials, embedding composition or bonding elements without further additives and may additionally contain one or more adhesive components d) selected from the group consisting of resins.

Possible further additional adhesive components d) are aliphatic and cycloaliphatic or aromatic hydrocarbon resins. These can be prepared by polymerization of particular resin oil fractions obtained in the processing of petroleum. Such resins, which can, for example, be modified by hydrogenation or functionalization, can be obtained, for example, under the trade names Eastoflex®, RegalREZ®, Kristalex®, Eastotac®, Piccotac® (Eastman Chemical Company) or Escorez® (ExxonMobil Chemical Company).

Further possible additional adhesive components d) are polyterpene resins prepared by polymerization of terpenes, for example pinene, in the presence of Friedel Crafts catalysts, likewise hydrogenated polyterpenes, copolymers and terpolymers of natural terpenes, for example styrene-terpene or α-methylstyrene-terpene copolymers. Further possibilities are natural and modified rosins, in particular resin esters, glyceryl esters of tree resins, pentaerythrityl esters of tree resins and tall oil resins and their hydrogenated derivatives and also phenol-modified pentaerythrityl esters of resins and phenol-modified terpene resins.

The abovementioned resins d) are present in the embedding composition of the invention, either individually or in any combination, in proportions by weight, based on the total weight of the composition, in the range from 0 to 90% by weight, preferably from 10 to 50% by weight, particularly preferably from 15 to 40% by weight.

In a very particularly preferred embodiment, the embedding composition contains one or more adhesive components d) selected from among amorphous poly-alpha-olefins (=APAOs), e.g. the grades of the Vestoplast® series (Degussa) or the Rextac® grades from Huntsman, aliphatic, cycloaliphatic or aromatic hydrocarbon resins as can be obtained, for example, under the trade name Escorez® from Exxon Mobil, also polyisobutylene, which is obtainable, for example, under the trade name Oppanol® from BASF. It is also possible for other polyolefins, for instance low-pressure polyethylenes as are available, for example, under the name Affinity® from Dow Chemical, also high-pressure polyethylenes including those containing polar comonomers, e.g. ethylene-vinyl acetate, to be present. The total mixture of the embedding compositions made up in this way has a viscosity in the range from 100 to 10 000 mPa·s at 170° C., preferably from 120 to 9000 mPa·s at 170° C., particularly preferably from 130 to 8000 mPa·s at 170° C.

If appropriate, the embedding compositions of the invention can additionally contain pigments, dyes, antioxidants, odor binders, antimicrobial active substances, light stabilizers, fragrances, bonding agents and additives for increasing the thermal conductivity and/or increasing/reducing the electrical conductivity (e.g. copper, graphite). Such additives which can be used are known to those skilled in the art and are therefore not described in detail here.

The waxes based on metallocene-catalyzed polyolefins which are present in the embedding compositions used according to the invention are prepared using metallocene compounds of the formula I as catalyst.

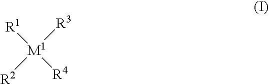

This formula also encompasses compounds of the formula Ia,

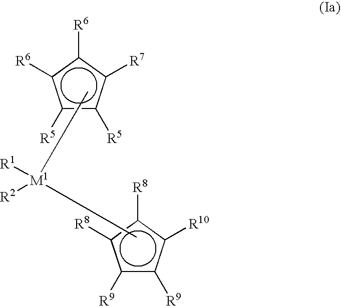

of the formula Ib,

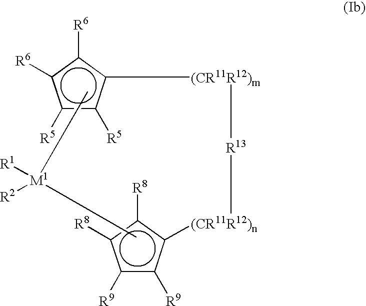

and of the formula Ic.

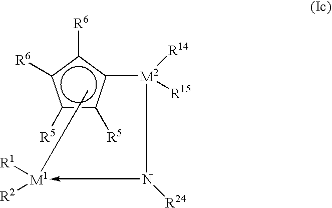

In the formulae I, Ia and Ib, M¹ is a metal of group IVb, Vb or VIb of the Periodic Table, for example titanium, zirconium, hafnium, vanadium, niobium, tantalum, chromium, molybdenum, tungsten, preferably titanium, zirconium and hafnium.

R¹ and R² are identical or different and are each a hydrogen atom, a C₁-C₁₀—, preferably C₁-C₃-alkyl group, in particular methyl, a C₁-C₁₀—, preferably C₁-C₃-alkoxy group, a C₆-C₁₀—, preferably C₆-C₈-aryl group, a C₆-C₁₀—, preferably C₆-C₈-aryloxy group, a C₂-C₁₀—, preferably C₂-C₄-alkenyl group, a C₇-C₄₀—, preferably C₇-C₁₀-arylalkyl group, a C₇-C₄₀—, preferably C₇-C₁₂-alkylaryl group, a C₈-C₄₀—, preferably C₈-C₁₂-arylalkenyl group or a halogen atom, preferably a chlorine atom.

R³ and R⁴ are identical or different and are each a monocyclic or polycyclic hydrocarbon radical which together with the central atom M¹ can form a sandwich structure. R³ and R⁴ are preferably cyclopentadienyl, indenyl, tetrahydroindenyl, benzoindenyl or fluorenyl, where the basic molecules may bear additional substituents or be joined to one another. In addition, one of the radicals R³ and R⁴ can be a substituted nitrogen atom, where R²⁴ has one of the meanings of R¹⁷ and is preferably methyl, tert-butyl or cyclohexyl.

R⁵, R⁶, R⁷, R⁸, R⁹ and R¹⁰ are identical or different and are each a hydrogen atom, a halogen atom, preferably a fluorine, chlorine or bromine atom, a C₁-C₁₀—, preferably C₁-C₄-alkyl group, a C₆-C₁₀—, preferably C₆-C₈-aryl group, a C₁-C₁₀—, preferably C₁-C₃-alkoxy group, an —NR¹⁶₂—, —SR¹⁶—, —OSiR¹⁶₃—, —SiR¹⁶₃— or —PR¹⁶₂ radical, where R¹⁶ is a C₁-C₁₀—, preferably C₁-C₃-alkyl group or C₆-C₁₀—, preferably C₆-C₈-aryl group or in the case of radicals containing Si or P may also be a halogen atom, preferably a chlorine atom, or two adjacent radicals R⁵, R⁶, R⁷, R⁸, R⁹ or R¹⁰ together with the carbon atoms connecting them form a ring. Particularly preferred ligands are the substituted compounds of the basic molecules cyclopentadienyl, indenyl, tetrahydroindenyl, benzoindenyl or fluorenyl.
R¹³ is

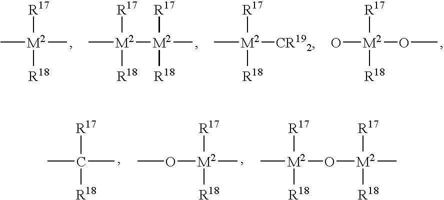

═BR¹⁷, ═AlR¹⁷, —Ge—, —Sn—, —O—, —S—, ═SO, ═SO₂, ═NR¹⁷, ═CO, ═PR¹⁷ or ═P(O)R¹⁷, where R¹⁷, R¹⁸ and R¹⁹ are identical or different and are each a hydrogen atom, a halogen atom, preferably a fluorine, chlorine or bromine atom, a C₁-C₃₀—, preferably C₁-C₄-alkyl group, in particular a methyl group, a C₁-C₁₀-fluoroalkyl group, preferably a CF₃ group, a C₆-C₁₀-fluoroaryl group, preferably a pentafluorophenyl group, a C₆-C₁₀—, preferably C₆-C₈-aryl group, a C₁-C₁₀—, preferably C₁-C₄-alkoxy group, in particular a methoxy group, a C₂-C₁₀—, preferably C₂-C₄-alkenyl group, a C₇-C₄₀—, preferably C₇-C₁₀-aralkyl group, a C₈-C₄₀—, preferably C₈-C₁₂-arylalkenyl group or a C₇-C₄₀—, preferably C₇-C₁₂-alkylaryl group, or R¹⁷ and R¹⁸ or R¹⁷ and R¹⁹ in each case together with the atoms connecting them form a ring.
M² is silicon, germanium or tin, preferably silicon or germanium. R¹³ is preferably ═CR¹⁷R¹⁸, ═SiR¹⁷R¹⁸, ═GeR¹⁷R¹⁸, —O—, —S—, ═SO, ═PR¹⁷ or ═P(O)R¹⁷.
R¹¹ and R¹² are identical or different and have one of the meanings of R¹⁷. m and n are identical or different and are each zero, 1 or 2, preferably zero or 1, where m plus n is zero, 1 or 2, preferably zero or 1.
R¹⁴ and R¹⁵ have the meanings of R¹⁷ and R¹⁸.
Specific examples of suitable metallocenes are:
bis(1,2,3-trimethylcyclopentadienyl)zirconium dichloride,
bis(1,2,4-trimethylcyclopentadienyl)zirconium dichloride,
bis(1,2-dimethylcyclopentadienyl)zirconium dichloride,
bis(1,3-dimethylcyclopentadienyl)zirconium dichloride,
bis(1-methylindenyl)zirconium dichloride,
bis(1-n-butyl-3-methylcyclopentadienyl)zirconium dichloride,
bis(2-methyl-4,6-di-i-propylindenyl)zirconium dichloride,
bis(2-methylindenyl)zirconium dichloride,
bis(4-methylindenyl)zirconium dichloride,
bis(5-methylindenyl)zirconium dichloride,
bis(alkylcyclopentadienyl)zirconium dichloride,
bis(alkylindenyl)zirconium dichloride,
bis(cyclopentadienyl)zirconium dichloride,
bis(indenyl)zirconium dichloride,
bis(methylcyclopentadienyl)zirconium dichloride,
bis(n-butylcyclopentadienyl)zirconium dichloride,
bis(octadecylcyclopentad ienyl)zi rconium dichloride,
bis(pentamethylcyclopentadienyl)zirconium dichloride,
bis(trimethylsilylcyclopentadienyl)zirconium dichloride,
biscyclopentadienylzirconiumdibenzyl,
biscyclopentadienylzirconiumdimethyl,
bistetrahydroindenylzirconium dichloride,
dimethylsilyl-9-fluorenylcyclopentadienylzirconium dichloride,
dimethylsilylbis-1-(2,3,5-trimethylcyclopentadienyl)zirconium dichloride,
dimethylsilylbis-1-(2,4-dimethylcyclopentadienyl)zirconium dichloride,
dimethylsilylbis-1-(2-methyl-4,5-benzoindenyl)zirconium dichloride,
dimethylsilylbis-1-(2-methyl-4-ethylindenyl)zirconium dichloride,
dimethylsilylbis-1-(2-methyl-4-i-propylindenyl)zirconium dichloride,
dimethylsilylbis-1-(2-methyl-4-phenylindenyl)zirconium dichloride,
dimethylsilylbis-1-(2-methylindenyl)zirconium dichloride,
dimethylsilylbis-1-(2-methyltetrahydroindenyl)zirconium dichloride,
dimethylsilylbis-1-indenylzirconium dichloride,
dimethylsilylbis-1-indenylzirconiumdimethyl,
dimethylsilylbis-1-tetrahydroindenylzirconium dichloride,
diphenylmethylene-9-fluorenylcyclopentadienylzirconium dichloride,
diphenylsilylbis-1-indenylzirconium dichloride,
ethylenebis-1-(2-methyl-4,5-benzoindenyl)zirconium dichloride,
ethylenebis-1-(2-methyl-4-phenylindenyl)zirconium dichloride,
ethylenebis-1-(2-methyltetrahydroindenyl)zirconium dichloride,
ethylenebis-1-(4,7-dimethylindenyl)zirconium dichloride,
ethylenebis-1-indenylzirconium dichloride,
ethylenebis-1-tetrahydroindenylzirconium dichloride,
indenylcyclopentadienylzirconium dichloride,
isopropylidene(1-indenyl)(cyclopentadienyl)zirconium dichloride,
isopropylidene(9-fluorenyl)(cyclopentadienyl)zirconium dichloride,
phenylmethylsilylbis-1-(2-methylindenyl)zirconium dichloride,
and also the alkyl or aryl derivatives of each of these metallocene dichlorides.

To activate the single-site catalyst systems, suitable cocatalysts are used. Suitable cocatalysts for metallocenes of the formula I are organoaluminum compounds, in particular aluminoxanes, or else aluminum-free systems such as R²⁰ₓNH₄₋ₓBR²¹₄, R²⁰ₓPH₄₋ₓBR²¹₄, R²⁰₃CBR²¹₄ or BR²¹₃. In these formulae, x is from 1 to 4, the radicals R²⁰ are identical or different, preferably identical, and are each C₁-C₁₀-alkyl or C₆-C₁₈-aryl or two radicals R²⁰ together with the atom connecting them form a ring, and the radicals R²¹ are identical or different, preferably identical, and are each C₆-C₁₈-aryl which may be substituted by alkyl, haloalkyl or fluorine. In particular, R²⁰ is ethyl, propyl, butyl or phenyl and R²¹ is phenyl, pentafluorophenyl, 3,5-bis-trifluoromethylphenyl, mesityl, xylyl or tolyl.

In addition, a third component is frequently necessary to maintain protection against polar catalyst poisons. Organoaluminum compounds such as triethylaluminum, tributylaluminum and others and also mixtures of these are suitable for this purpose.

Depending on the process, supported single-site catalysts can also be used. Preference is given to catalyst systems in which the residual contents of support material and cocatalyst in the product do not exceed a concentration of 100 ppm.

Processes for preparing such metallocene-catalyzed polyolefins are described, for example, in the prior art, e.g. EP-A-0 321 851, EP-A-0 321 852, EP-A-0 384 264, EP-A-0 571 882 and EP-A-0 890 584.

The synthesis of the waxes a) can be carried out under a pressure of from 0.1 to 10 MPa in the gas phase or in suspension or in solution in a suitable suspension medium/solvent according to known technologies.

Metallocene catalysts for preparing metallocene-catalyzed polyolefins are chiral or achiral transition metal compounds of the formula M¹Lₓ. The transition metal compound M¹Lₓ contains at least one central metal atom M¹ to which at least one π-ligand, e.g. a cyclopentadienyl ligand, is bound. In addition, substituents such as halogen, alkyl, alkoxy or aryl groups can be bound to the central metal atom M¹. M¹ is preferably an element of main group III, IV, V or VI of the Periodic Table of the Elements, e.g. Ti, Zr or Hf. The term cyclopentadienyl ligand encompasses unsubstituted cyclopentadienyl radicals and substituted cyclopentadienyl radicals such as methylcyclopentadienyl, indenyl, 2-methylindenyl, 2-methyl-4-phenylindenyl, tetrahydroindenyl or octahydrofluorenyl radicals. The π-ligands can be bridged or unbridged, with single and multiple bridges, including ring systems, being possible. The term metallocene also encompasses compounds having more than one metallocene fragment, known as multinuclear metallocenes. This can have any substitution pattern and bridging variants. The individual metallocene fragments of such multinuclear metallocenes can be of the same type or be different from one another. Examples of such multinuclear metallocenes are, for example, described in EP-A-0 632 063.

Examples of general structural formulae of metallocenes and of their activation by means of a cocatalyst are given, inter alia, in EP-A-0 571 882.

Since the polyolefins prepared in this way do not contain any reactive chemical groups, they are chemically inert so that no chemical reaction with commercial materials such as metals and plastics takes place, which is of extraordinary advantage in terms of the design of the groups of components and the life.

The waxes a) used for producing the embedding composition of the invention for use in electronic and mechanical groups of components are present in pelletized, powder or block form and can be shaped without problems to produce plates, profiles, three-dimensional bodies.

The waxes a) based on metallocene-catalyzed polyolefins which are used have a very high enthalpy of fusion (from 70 to 280 J/g at densities of from 0.9 kg/dm³ to 0.97 kg/m³). The melting points are in the range from 80 to 160° C. In addition, they are toxicologically acceptable, chemically inert and do not display demixing. The compositions of the invention are suitable for use in the production of embedding compositions and construction materials, in particular for the production of connecting elements for fastening and fixing of electric and mechanical components in groups of components and assemblies, e.g. for fastening the stator in immersion pump assemblies.

A manufacturer of the abovementioned metallocene-catalyzed polyolefin waxes which can be used (Licocene® Performance Polymers) is, for example, Clariant Produkte (Deutschland) GmbH.

The embedding composition of the invention has the advantage over construction materials known from the prior art that it has a shorter setting time (solidification time) without suffering from a loss of adhesion and cohesion, displays improved tensile strength (tensile N) and stiffness (elongation) without being brittle and at the same time has a favorable viscosity behavior and is also toxicologically and ecologically acceptable and can be handled in a simple fashion.

The elongation behavior or the stiffness of the embedding compositions, determined as “elongation in %” is ideal for the intended purpose, i.e. good stiffness is achieved without the compositions being brittle and cracks and brittle fracture occurring in use.

Embedding compositions having very high proportions of filler (sand) display virtually no elongation (elongation=0%) and have a high tendency to suffer from crack formation and brittle fracture.

Since the setting times (solidification time) of the embedding compositions are very short, the connecting elements can be assembled in a simple manner within a very short time. Embedding compositions having a proportion of filler above 40% by weight, based on the total compositions, are particularly advantageous.

A further advantage of the embedding compositions of the invention is the fact that waxes and metallocene-catalyzed polyolefins display thermoplastic behavior and, in contrast to thermosets (epoxy resins), have excellent creep behavior. This leads to the embedding composition body (sand body) undergoing self compaction during the time of operation.

### EXAMPLES

The following examples illustrate the invention without restricting it to the specific embodiments described. Percentages are, unless indicated otherwise, percentages by weight.

The melt viscosities were determined in accordance with DIN 53019 using a rotational viscometer, the dropping points were determined in accordance with ASTM D3954, the ring/ball softening points were determined in accordance with ASTM D3104 in the case of pure Licocene®. The weight average molar mass M_{w} and the number average molar mass Mₙ were determined by gel permeation chromatography at a temperature of 135° C. in 1,2-dichlorobenzene.

The values for the storage moduli G′ and the loss moduli G″ were determined in the temperature range from −40 to 200° C. at 1 Hz by DMA using a TA Instruments Q800 compression kit. The specimen (dimensions: 29×9.5×4.5 mm) was stored under standard conditions for 24 hours before testing.

The tensile strength (tensile N) is determined by subjecting a test specimen (tensile bar) to a tensile force and measuring the force at which the test specimen ruptures. The elongation at break in % is the extensibility of the test specimen before it ruptures.

The ethylene-propylene copolymer Licocene® Performance Polymer used according to the invention was prepared by methods reported in the prior art (EP 0 384 264).

Formulation 1 (F1)

| | |
|---|---|
| Licocene ® PP 6102 | 90% |
| Sand | 10% |

Formulation 2 (F2)

| | |
|---|---|
| Licocene ® PP 6102 | 70% |
| Sand | 30% |

Formulation 3 (F3)

| | |
|---|---|
| Licocene ® PP 6102 | 50% |
| Sand | 50% |

Formulation 4 (F4)

| | |
|---|---|
| Licocene ® PP 6102 | 30% |
| Sand | 70% |

Formulation 5 (F5)

| | |
|---|---|
| Licocene ® PP 6102 | 10% |
| Sand | 90% |

Formulation 6 (F6)

| | |
|---|---|
| Licocene ® PP 2602 | 30% |
| Sand | 70% |

Formulation 7 (F7)

| | |
|---|---|
| Licocene ® PP 1602 | 30% |
| Sand | 70% |

### Ball Indentation Hardnesses:

| | | | | Penetration | | | | | |
|---|---|---|---|---|---|---|---|---|---|
| | | Load | Diameter | depth [μm] | | DGF M-III 9c (98) | Based on ISO 2039-1 | Proportion [%] | |
| Form. | Product | [kg] | [m] | Loading | Unloading | [KPa] | [N/mm²] | Elastic | Plastic |
| F1 | 10% sand + 90% PP 6102 | 10 | 0.005 | 219 | 165 | 28 517 | 29 | 25 | 75 |
| F2 | 30% sand + 70% PP 6102 | 10 | 0.005 | 220 | 181 | 28 387 | 28 | 18 | 82 |
| F3 | 50% sand + 50% PP 6102 | 10 | 0.005 | 214 | 167 | 29 183 | 29 | 22 | 78 |
| F4 | 70% sand + 30% PP 6102 | 10 | 0.005 | 242 | 223 | 25 807 | 26 | 8 | 92 |
| F5 | 90% sand + 10% PP 6102 | 10 | 0.005 | >1400 | | — | — | — | — |
| F6 | 30% sand + 70% PP 2602 | 10 | 0.005 | 317 | 138 | 19 701 | 20 | 56 | 44 |
| F7 | 30% sand + 70% PP 1602 | 10 | 0.005 | 1089 | 378 | 5735 | 6 | 65 | 35 |

### Mechanical Strengths:

| | | Modulus of | Maximum | Force at | |
|---|---|---|---|---|---|
| | | elasticity | force | break | Elongation at |
| | | E modulus | Rm | RB | maximum force |
| Form. | Product | MPa | N/mm² | N/mm² | {epsilon}-F max % |
| | Licocene PP 1602 | 20 | 3 | — | 225 |
| | Licocene PP 2602 | 90 | 7 | — | 40 |
| F 7 | 30% sand + | 160 | 5 | 4 | 9 |
| | 70% PP 1602 | | | | |
| F 6 | 30% sand + | 500 | 7 | 6 | 4 |
| | 70% PP 2602 | | | | |

### Dynamic Mechanical Analysis (DMA):

| | | DMA | | | | |
|---|---|---|---|---|---|---|
| | | | Storage | Loss | | Max. tan |
| | | Temperature | modulus | modulus | | delta/temperature |
| Formulation | Product | in ° C. | G′ in MPa | G″ in MPa | Tan delta | in ° C. |
| F1 | 90% Licocene ® | 0 | 27.37 | 3.65 | 0.13 | 68 |
| | PP 6102 + 10% | 20 | 10.11 | 1.15 | 0.12 | |
| | sand | 50 | 3.50 | 0.66 | 0.19 | |
| | | 100 | 0.69 | 0.13 | 0.19 | |
| F2 | 70% Licocene ® | 0 | 27.48 | 3.38 | 0.12 | 74 |
| | PP 6102 + 30% | 20 | 11.00 | 1.26 | 0.11 | |
| | sand | 50 | 4.50 | 0.90 | 0.20 | |
| | | 100 | 0.72 | 0.15 | 0.21 | |
| F3 | 50% Licocene ® | 0 | 24.97 | 2.76 | 0.11 | 66 |
| | PP 6102 + 50% | 20 | 10.61 | 1.25 | 0.12 | |
| | sand | 50 | 5.26 | 1.08 | 0.21 | |
| | | 100 | 1.10 | 0.23 | 0.20 | |
| F4 | 30% Licocene ® | 0 | 63.35 | 7.81 | 0.12 | 68 |
| | PP 6102 + 70% | 20 | 31.68 | 5.01 | 0.16 | |
| | sand | 50 | 14.11 | 3.67 | 0.26 | |
| | | 100 | 4.10 | 1.31 | 0.32 | |
| F5 | 10% Licocene ® | 0 | 29.25 | 2.66 | 0.09 | 69 |
| | PP 6102 + 90% | 20 | 17.09 | 2.16 | 0.13 | |
| | sand | 50 | 7.27 | 1.35 | 0.19 | |
| | | 100 | 4.76 | 1.40 | 0.30 | |
| F6 | 30% Licocene ® | 0 | 14.38 | 2.93 | 0.20 | 68 |
| | PP 2602 + 70% | 20 | 4.40 | 0.59 | 0.13 | |
| | sand | 50 | 1.26 | 0.16 | 0.13 | |
| | | 100 | — | — | — | |
| F7 | 30% Licocene ® | 0 | 10.64 | 3.65 | 0.34 | 63 |
| | PP 1602 + 70% | 20 | 3.30 | 0.51 | 0.15 | |
| | sand | 50 | 0.81 | 0.11 | 0.14 | |
| | | 100 | — | — | — | |
| Licocene ® | Neat | 0 | 1.58 | 0.88 | 0.55 | 64 |
| PP 1602 | | 20 | 0.06 | 0.01 | 0.19 | |
| | | 50 | 0.02 | 0.002 | 0.13 | |
| | | 100 | — | — | — | |
| Licocene ® | Neat | 0 | 9.24 | 3.61 | 0.38 | 61 |
| PP 2602 | | 20 | 1.37 | 0.24 | 0.18 | |
| | | 50 | 0.37 | 0.05 | 0.09 | |
| | | 100 | — | — | — | |
| Licocene ® | Neat | 0 | 17.59 | 2.24 | 0.12 | 81 |
| PP 6102 | | 20 | 7.97 | 0.94 | 0.12 | |
| | | 50 | 3.26 | 0.57 | 0.18 | |
| | | 100 | 0.56 | 0.13 | 0.23 | |

General method of production: the waxes and metallocene-catalyzed polyolefins used are melted at <200° C. until they are molten and, for example, drawn into the filler (sand) by the vacuum method or the liquid wax and metallocene-catalyzed polyolefin is poured or pressed under gentle pressure into the filler.

1. An embedding composition comprising
a) one or more waxes based on metallocene-catalyzed polyolefins having
a ring/ball softening point in the range from 50 to 165° C.,
a melt viscosity, measured at a temperature of 170° C., in the range from 20 to 40 000 mPa·s and
a glass transition temperature T_{g} of not more than −10° C. and
b) one or more inorganic fillers.

2. The embedding composition as claimed in claim 1, wherein the one or more metallocene-catalyzed polyolefin waxes are prepared by polymerization of ethylene, propylene or both in the presence of metallocenes as catalyst.

3. The embedding composition as claimed in claim 1, wherein the one or more metallocene-catalyzed polyolefin waxes a) have a melt flow index MFI of more than 30 g/10 min, measured in accordance with ISO 1133 at a temperature of 190° C. and a load of 2.16 kg.

4. The embedding composition as claimed in claim 1, wherein the one or more inorganic fillers are selected from the group consisting of sands, chalks, natural milled or precipitated calcium carbonates, calcium-magnesium carbonates, calcium oxide, silicates, barte, graphite, carbon blacks, vermiculite, mica, talc and sheet silicates.

5. The embedding composition as claimed in claim 1, wherein the weight ratio of one or more metallocene-catalyzed polyolefin wax to inorganic filler is in the range from 1:99 to 99:1.

6. The embedding composition as claimed in claim 1, wherein the composition comprises from 61 to 89% by weight of the one or more metallocene-catalyzed polyolefin waxes and from 11 to 39% by weight of one or more inorganic fillers.

7. The embedding composition as claimed in claim 1, wherein the composition contains, in addition to the components a) and b), a component c), where component c) is one or more copolymer waxes modified to be polar and prepared by reaction of the polyolefin a) with an α,β-unsaturated carboxylic acid or derivative thereof in the presence of free-radical initiators.

8. The embedding composition as claimed in claim 1, wherein the composition additionally contains from 0 to 90% by weight of aliphatic and cycloaliphatic or aromatic hydrocarbon resins as component d), based on the total weight of the composition.

9. The embedding composition as claimed in claim 8, wherein the composition has a viscosity in the range from 100 to 10 000 mPa·s at 170° C.

10. The embedding composition as claimed in claim 1 further comprising additives selected from the group consisting of: pigments, dyes, antioxidants, odor binders, antimicrobial active substances, light stabilizers, fragrances, bonding agents and additives for increasing the thermal conductivity and/or increasing/reducing electrical conductivity.

11. A embedding composition consisting essentially of Licocene® Performance Polymer and a filler.

12. An article comprising an embedding composition as claimed in claim 1 wherein the article is in the form of construction materials, production of connecting elements for the encapsulation of electronic circuits, electric appliances, motors, pumps, individual electrical components, groups of electronic components, a stator of immersion pump assemblies or a stator of an electric motor.
